(19) United States
(12) Patent Application Publication
(10) Pub. No.: US 2026/0266242 A1
(43) Pub. Date: Sep. 10, 2026

(54) COMBUSTION CHAMBER FOR PRODUCING HOT GAS

(71) Applicant: MIPRONS SRL, Segni (RM) (IT)

(72) Inventor: Angelo MINOTTI, Segni (RM) (IT)

(21) Appl. No.: 19/166,922

(22) PCT Filed: Mar. 19, 2024
(86) PCT No.: PCT/IB2024/052634

§ 371 Date: Sep. 19, 2025

(30) Foreign Application Priority Data
Mar. 20, 2023 (IT) 102023000005163

(51) Int. Cl. F02K 9/95; F23M 20/00; F23Q 3/00

(52) U.S. Cl. CPC F02K 9/95; F23M 20/00; F23Q 3/008

(57) ABSTRACT

A combustion chamber for producing hot gas, has a container (1), having a container wall (2), at least one inlet duct (C1, C2) for the introduction of a combustible gas and a comburent gas inside the container (1), an igniter in the form of at least one electrode (E1, E2) that is capable of generating a spark inside the container (1), and an exhaust duct(S). At least an inlet arms (B1, B2) contains at least one of the inlet ducts (C1, C2) and the passageways (P1, P2) for said at least one electrode (E1, E2), which is surrounded by electrically insulating material. The inlet ducts (C1, C2) and the passageways (P1, P2) have mutually parallel offset axes.

### FIELD OF THE INVENTION

The present invention relates to a combustion chamber for the production of hot gas. The hot gas can be used for propulsion or for production of electricity. Connected to the combustion chamber are combustible and comburent tanks or an electrolyser in which an electrolyte, such as water, is electrolysed to produce a combustible gas, such as hydrogen, and a comburent gas, such as oxygen. At a predetermined pressure the gases are ignited and the combustion products are discharged from the combustion chamber through an exhaust outlet.

### PRIOR ART

U.S. Pat. No. 4,345,729 describes a thruster unit for a spacecraft whose attitude is monitored by a control system. The thruster unit includes a container, an electrolyser within the container, means for supplying electrolyte to the electrolyser, control means responsive to the attitude control system for initiating operation of the electrolyser to produce combustible gases from the electrolyte when a change in attitude of the spacecraft is desired, means for sensing when the pressure within the container reaches a predetermined level, ignition means for igniting the combustible gases within the container at the predetermined pressure level, and means for allowing the combustion gases to emerge from the container to effect a change in attitude of the spacecraft. The control means is further responsive to the spacecraft attitude control system to terminate the operation of the electrolyte unit when the desired spacecraft attitude change has been completed.

WO 2019/021234 A9 describes a space propulsion system, comprising a combustion chamber and a supersonic nozzle. The combustion chamber is made of a cylindrical container having cylindrical walls. A first end of the cylindrical container is provided with a first injection duct for a comburent in a direction tangent to the cylindrical walls so as to induce a helical combustion path in the combustion chamber, and a second injection duct for a combustible in a direction perpendicular to the cylindrical wall. The end of the cylindrical container opposite to the first end is provided with an exhaust duct arranged in a direction tangent to the cylindrical wall so as to receive and direct the helical path to the supersonic nozzle. The cylindrical walls have a deposit of catalytic material to accelerate the combustion reaction.

As an alternative to U.S. Pat. No. 4,345,729, as regards the triggering of combustion, the catalytic combustion used in WO 2019/021234 A9 by means of deposition of catalyst, such as platinum, on the walls of the chamber, therefore without spark, has a low temperature, given that the melting temperature of platinum is 1769° C.

The use of a pre-mixing chamber serves to create ideal conditions of flame temperature and stability, and more, to have efficient combustion in the chamber. Usually, high combustion temperatures require a complex cooling system for cooling both the igniter and the combustion chamber, also using the oxidizer itself and the heat to be eliminated to preheat fresh flows entering the igniter and/or the combustion chamber.

US 2019/0032606 A1 describes an injector element for injecting a mixture of at least a first propellant and a second propellant into a combustion chamber, in particular for a rocket engine. The injector element includes a first tubular wall defining a first duct for injecting the first propellant, and a second wall surrounding the first wall and defining, between the first wall and the second wall, a second duct for injecting the second propellant. The first wall includes a first electrode for igniting the mixture by electrical discharge.

U.S. Pat. No. 5,636,511 describes a pre-ignition torch that produces a pilot flame in a wall of a gas turbine combustor, for the purpose of projecting a flame into the combustor as a means of ignition. The torch preferably is a catalytic igniter which operates over a wide range of air/fuel ratios.

Both US 2019/0032606 A1 and U.S. Pat. No. 5,636,511 describe axisymmetric structures to allow the fluid to be ignited to come into direct contact with the electrode in the igniter itself, either to create a combustion prior to the engine combustion chamber or of the turbine, and to lower the temperature of the electrode. The application of these structures on micro-engines would not be possible.

In the field of minisatellites and small energy systems in general, where the dimensions are very small and therefore each component requires to be miniaturized, the combustion chambers must also be miniaturized. Consequently, the dimensions of the igniter must be very small. Igniter insertion into the combustion chamber must be well studied, as drilling, threading or sealing are very difficult to achieve in micro-sized systems, given that its operation requires electrical insulation with respect to the chamber to allow there to be the spark.

Furthermore, to increase efficiency, high temperatures are reached in the reference combustion chambers. Consider that the flames produced by the combustion of hydrogen and oxygen, especially in stoichiometric conditions, are at temperatures of over 3,000°C.

### SUMMARY OF THE INVENTION

Therefore, an object of the present invention is to provide, with the use of materials suitable to resist up the temperatures indicated above, technical solutions that allow the creation of particularly efficient combustion chambers in terms of dimensions and performance.

Yet another object of the invention is to create a simple combustion chamber, but which at the same time provides various embodiments.

Therefore, the invention provides a combustion chamber for producing hot gas, comprising a container, having at least a container wall, at least one inlet duct for the introduction of a combustible gas and a comburent gas inside the container, an igniter in the form of at least one electrode that is inserted in a corresponding passageway and is capable of generating a spark inside the container, and an exhaust duct, wherein at least an inlet arm contains at least one among the inlet ducts and the passageways for said at least one electrode, which is surrounded by electrically insulating material, said inlet ducts and passageways having mutually parallel offset axes.

The provision of non-coaxial inlet ducts and passageways, differently from those in the documents US 2019/0032606 A1 and U.S. Pat. No. 5,636,511 cited above, allows the dimensions of a combustion chamber to be significantly reduced; this is particularly useful in minisatellites and small energy systems in general.

### BRIEF DESCRIPTION OF THE DRAWINGS

Objects and features of the present invention will be most clear from the description of some embodiments of a combustion chamber, with reference to the attached figures in which:

FIG. 1 is a general schematic perspective view of a first variant of a two-inlet combustion chamber according to the present invention;

FIG. 2 is an end view of an inlet arm of the first combustion chamber variant in FIG. 1;

FIG. 3 is a schematic general perspective view of a first embodiment of a second variant of a two-inlet combustion chamber according to the present invention;

FIG. 4 is a perspective view of an embedding component contained within an inlet tube of the inlet arm in FIG. 3;

FIG. 5 is a partial transversal cross-section view of the two-inlet combustion chamber in FIG. 3 which uses the embedding component in FIG. 4;

FIG. 6 is a cross-section view of the second two-inlet combustion chamber in FIG. 3 with A-B trace planes in FIG. 5;

FIG. 7 is a partial cross-section view similar to that in FIG. 5 of a second embodiment of the two-inlet combustion chamber second variant with a single electrode according to the present invention;

FIG. 8 is a cross-section view of the second embodiment of the two-inlet combustion chamber second variant obtainable with cross-sectioning plans of trace A-B in FIG. 7;

FIG. 9 is a cross-section view of a third embodiment of the two-inlet combustion chamber second variant obtained as FIG. 8;

FIG. 10 is a cross-section view of a fourth embodiment of the two-inlet combustion chamber second variant obtained as FIG. 8;

FIG. 11 is a longitudinal cross-section view of a first embodiment of a single inlet combustion chamber third variant according to the present invention;

FIG. 12 is a longitudinal cross-section view of a second embodiment of the single inlet combustion chamber third variant according to the present invention;

FIG. 13 is a longitudinal cross-section view of a third embodiment of the single inlet combustion chamber third variant according to the present invention; and

FIG. 14 is a longitudinal cross-section view of a fourth embodiment of the single inlet combustion chamber third variant according to the present invention.

### DESCRIPTION OF THE EMBODIMENT

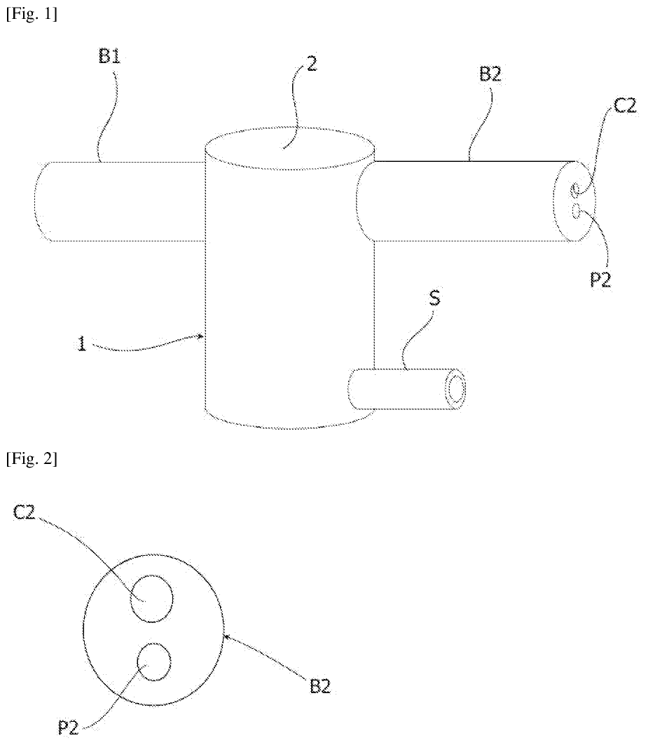

Initially, reference is made to FIG. 1 which schematically represents a perspective view of a two-inlet combustion chamber first variant for the production of hot gas.

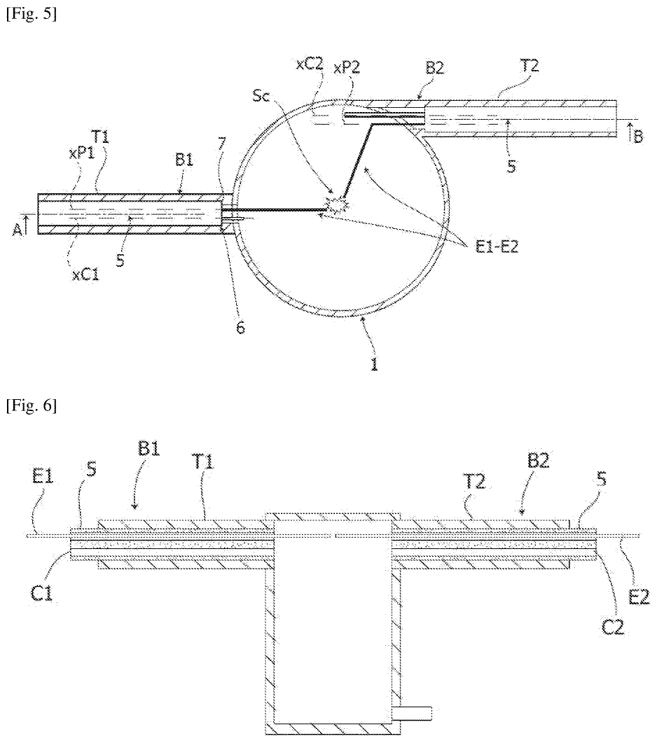

The two-inlet combustion chamber first variant is made up of a container 1, having at least one wall indicated generically as 2. Advantageously, the container 1 can be made of ceramic material and has two inlet arms B1, B2 also of ceramic material made in one piece with the container 1, and an exhaust duct S. The ceramic material is chosen because it is electrically insulating and capable of resisting high temperatures. The inlet arms B1 and B2 are positioned opposite but offset relative to the container 1, as shown in FIG. 5, which is a partially cross-sectioned schematic plan view of a second variant of a two-inlet combustion chamber, made with multiple materials.

Each inlet arm B1, B2, as shown in FIG. 2, which is an end view of the inlet arm B2, identical to the inlet arm B1, has, made inside it in any suitable way, an inlet duct C1, C2, respectively for the introduction of a combustible gas and a comburent gas, and a passageway P1, P2 for an electrode not shown in FIGS. 1 and 2.

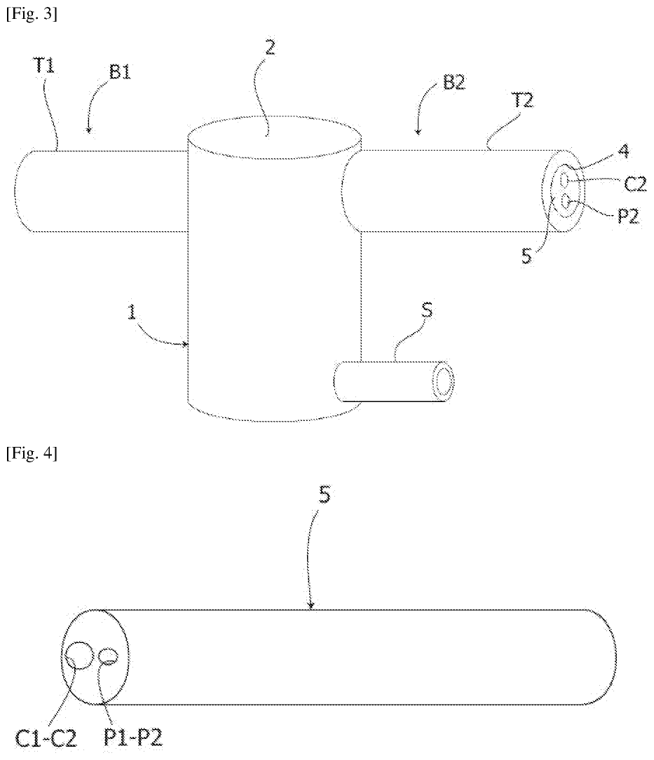

Reference is made now to FIG. 3 which is a general schematic perspective view of a first embodiment of a two-inlet combustion chamber second variant according to the present invention.

The two-inlet combustion chamber is made up of a container 1, having at least one wall indicated generically as 2, two inlet arms B1, B2 and an exhaust duct S. The inlet arms B1, B2 are made up of respective inlet tubes T1, T2, which they are in one piece with the container 1, and have an internal surface 4; inside each inlet tube T1, T2 is an embedding component similar to that shown in schematic perspective view in FIG. 4 and indicated generically as 5. The container 1 and the inlet tubes T1, T2 are made of metal and its alloys, of carbon or its fibres, or of ceramic material, or of a combination of the aforementioned materials. The embedding component 5 is made of an electrically insulating material, for example a ceramic material.

Inside the embedding component 5 inside the inlet tubes T1, T2, an inlet duct C1, and respectively C2, and a passageway P1, and respectively P2 are obtained in any suitable way. The embedding component 5 separates the conduit C1, C2 and the passageway P1, P2 from each other and both from the internal surface 4 of the inlet tube T1, T2. The function of the inlet duct C1, C2 and the P1, P2 passageway will be clarified later. The inlet duct C2 and the passageway P2 are shown in FIG. 3 as arranged vertically to each other and in FIG. 4 horizontal to each other. However, other configurations are possible based on design choices.

The arrangement of the inlet tubes with respect to the container 1, for both the first variant without the embedding component 5 and the second variant, is shown in the partial transversal cross-section view of the combustion chamber in FIG. 5. This arrangement is similar to that of the patent application WO 2019/021234 A9, in which are described a first injection duct for a comburent in a direction tangent to the cylindrical wall so as to induce a helical combustion path in the combustion chamber, and a second duct for injection of a combustible in a direction perpendicular to the cylindrical wall. According to the present invention one of or both the inlet ducts are combined with respective electrode passageways.

As shown in FIG. 5, the two inlet arms B1, B2 comprise a first inlet tube T1 and a second inlet tube T2, respectively. Both inside the first inlet tube T1 and the second inlet tube T2 there is an embedding component 5. In the latter there is an inlet duct C1, C2 for a combustible and a comburent respectively, and a passageway P1, P2 for an electrode. xC1, xC2 and xP1, xP2 indicate the axes of the respective inlet ducts and of the electrode passageways. It should be clear that the inlet ducts C1, C2 and the passageways P1, P2 have axes xC1, xC2, xP1, xP2 which are mutually offset or parallel not coinciding, both in the single inlet arm B1 or B2, and between the inlet arm B1 and inlet arm B2. The electrodes are indicated as E1 and E2, respectively. The electrodes E1 and E2, duly powered in a non-described manner, are capable of generating a spark Sc between them. Each ceramic embedding component 5 abuts with one of its ends 6 against a projection 7 obtained in each inlet tube T1, T2 near the container 1 and is held there by any suitable means. Alternatively, in the absence of the projection 7, the embedding component could be a tapered end to create a slightly conical coupling with the container 1.

Now also reference is made to FIG. 6 which represents a cross-section view of the two-inlet combustion chamber in FIG. 3 with trace planes A-B in FIG. 5. In this combustion chamber the first inlet tube T1 contains an inlet duct C1 for introducing a gas and a passageway P1 for housing an electrode E1, and the second inlet tube T2 contains an inlet duct C2 for introducing a gas and a passage P2 for housing an electrode E2. The relevant arrangement of the inlet ducts C1, C2 and the passageways P1, P2 in the respective inlet tubes T1, T2 is vertical.

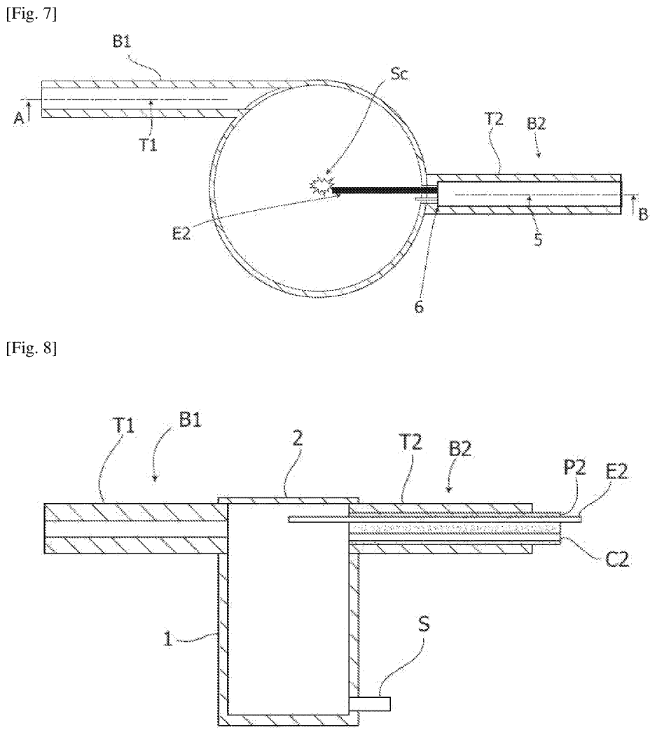

Similarly to FIG. 5, FIG. 7 is a partially cross-section view of a second embodiment of the two-inlet combustion chamber second variant with a single electrode according to the present invention. The first inlet tube T1 is used for the introduction of a comburent gas such as oxygen, and the second inlet tube T2 contains, inside an embedding component 5, an inlet duct C for the introduction of a combustible gas and a passageway P2 for housing an electrode E2. The electrode E2 is able to generate a spark inside the container 1 with said at least one container wall 2.

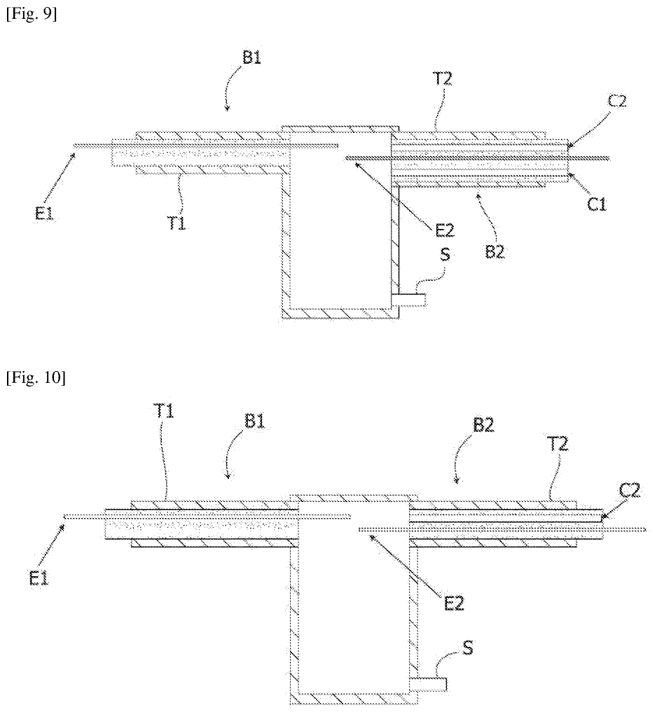

FIG. 9 shows a third embodiment of the two-inlet combustion chamber second variant. In this combustion chamber the first inlet tube T1 has a passageway P1 for housing a first electrode E1. The second inlet tube T2 contains a first inlet duct C1 for the introduction of a combustible gas, a second inlet duct C2 for the introduction of a comburent gas and a passageway P2 for housing a second electrode E2. The first electrode E1 and the second electrode E2 are capable of generating a spark between them inside container 1.

FIG. 10 shows a fourth embodiment of the two-inlet combustion chamber second variant. The first inlet tube T1 contains a passageway P1 for housing a first electrode E1. The second inlet tube T2 contains an inlet duct C2 for the introduction of a combustible gas and a comburent gas in a premixed condition and a passageway P2 for housing a second electrode E2. The first electrode E1 and the second electrode E2 are capable of generating a spark between them inside container 1.

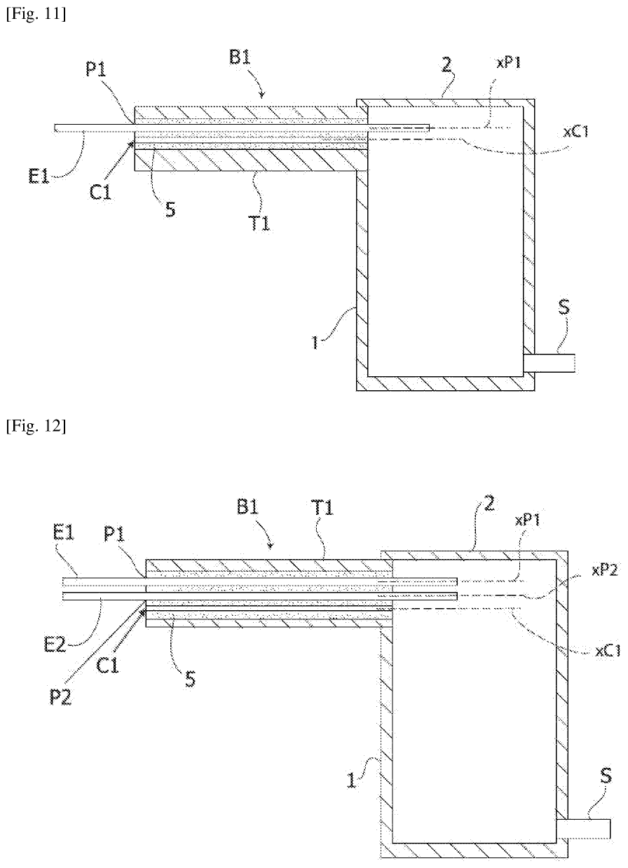

In the following FIGS. 11 to 14, a third combustion chamber is shown, in vertical cross-section view and in various embodiments, in which a single inlet arm B1 is provided, comprising an inlet tube T1.

With reference to FIG. 11, the inlet tube T1 contains an inlet duct C1 for the introduction of a combustible gas and a comburent gas in a premixed condition, and a passageway P1 for housing an electrode E1 arranged in such a way to generate a spark with the container wall 2 inside the container 1. xC1 and xP1 indicate the axes of the respective inlet duct and of the respective electrode passageway. The inlet duct C1 and the passageway P1 have axes xC1, xP1 which are vertically mutually offset.

With reference to FIG. 12, the inlet tube T1 contains an inlet duct C1 used for the introduction of a combustible gas and a comburent gas in a premixed condition, a first passageway P1 for housing a first electrode El and a second passageway P2 for housing a second electrode E2. The first electrode E1 and the second electrode E2 are arranged so as to generate a spark between them inside the container 1. xC1 and xP1, xP2 indicate the axes of the respective inlet ducts and of the electrode passageways. It should be clear that the inlet duct C1 and the passageways P1, P2 have axes xC1, xP1, xP2 which are mutually offset or parallel not coinciding in the sole arm B1.

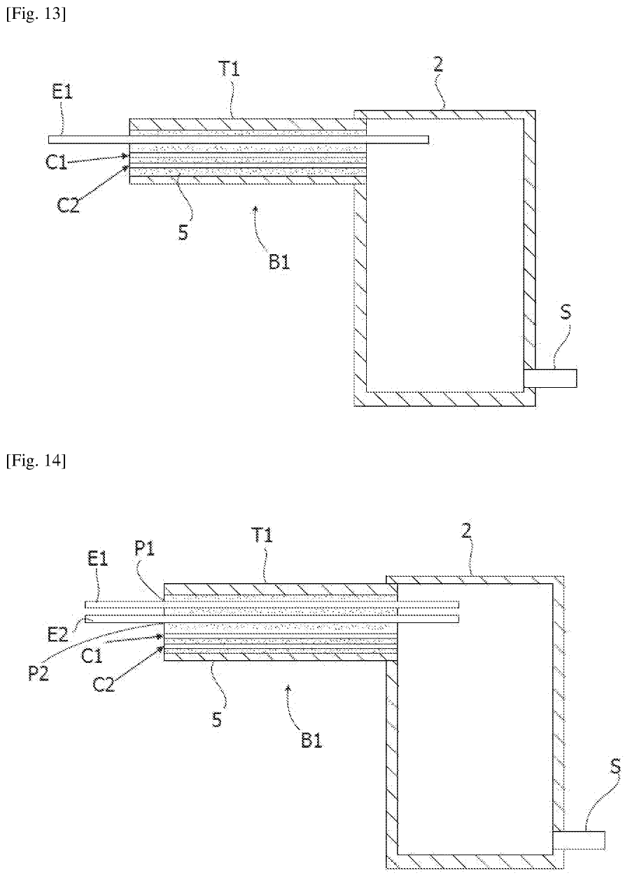

With reference to FIG. 13 the inlet tube T1 contains a first inlet duct C1 used for the introduction of a combustible gas and a second inlet duct C2 used for the introduction of a comburent gas, and a passageway, not indicated with reference numeral, for housing an electrode El arranged so as to generate a spark with the container wall 2 inside the container 1.

With reference to FIG. 14, the inlet tube T1 contains a first inlet duct C1 used for the introduction of a combustible gas and a second inlet duct C2 used for the introduction of a comburent gas, a first passageway P1 for the housing of a first electrode El and a second passageway P2 for housing a second electrode E2. The first electrode E1 and the second electrode E2 are arranged so as to generate a spark between them inside the container 1.

In brief, in the description of the various embodiments for the two combustion chambers with one or two inlets, various arrangements of the combustible gas and comburent gas inlet ducts and, above all, of the passageways of the electrode or electrodes which represent the igniter of choice for micro-applications have been described. The combustion chamber container may be made of a ceramic material. In the case of a material other than ceramic for the container, the embedding component allows the thermal, electrical and mechanical insulation of the electrodes with respect to the inlet tubes which could be made of metallic material. The currently preferred material for electrodes is tungsten which resists very high temperatures (3422° C.) and is a good electrical conductor. Tungsten wires, which are easily available on the market, have diameters of less than 1 mm and therefore have little influence on the internal fluid dynamics of the combustion chamber. The parallel configuration of the inlet ducts and passageways, orthogonal to the longitudinal axis of the combustion chamber, improves the thermal management of the system as it moves the electrode away from the hottest part of the chamber which is the one near the outlet. Ultimately, the offset of the axes of the inlet ducts and of the electrode passageways allows for effective thermal and electrical management in a micro-combustion chamber.

As regards the embedding component inside the inlet tube, easily workable ceramics can be used which resist very high temperatures, above 2500° C. and are by their nature thermally and electrically insulating.

The flow of combustible and comburent works as natural cooling, coming from tanks that are at temperatures even lower than 100° C., usually 30-60° C.

For the mechanical seal of the embedding component with the combustion chamber container, the embedding component could be pushed until it enters the chamber, creating a slightly conical coupling.

1. A combustion chamber for producing hot gas, comprising:
a container, having at least a container wall,
at least one inlet duct for the introduction of a combustible gas and a comburent gas inside the container,
an igniter in the form of at least one electrode that is inserted in a corresponding passageway and is capable of generating a spark inside the container, and
an exhaust duct,
least an inlet arm, containing at least one among the inlet ducts and the passageways for said at least one electrode, which is surrounded by electrically insulating material, said inlet ducts and passageways having mutually parallel offset axes.

2. The combustion chamber according to claim 1, wherein the combustion chamber has a first inlet arm and a second inlet arm.

3. The combustion chamber according to claim 2, wherein
the first inlet arm contains an inlet duct for the introduction of a combustible gas, and a passageway which houses a first electrode, and
the second inlet arm contains an inlet duct for the introduction of a comburent gas and a passageway which houses a second electrode,
Wherein the first electrode and the second electrode are arranged so as to generate a spark between them.

4. The combustion chamber according to claim 2, wherein
the first inlet arm is configured as an inlet tube for the introduction of a comburent gas, and
the second inlet arm contains an inlet duct for the introduction of a combustible gas and a passageway which houses an electrode so that the electrode is able to generate a spark with said container wall.

5. The combustion chamber according to claim 2, wherein
the first inlet arm contains a passageway which houses a first electrode, and
the second inlet arm contains a first inlet duct for the introduction of a combustible gas, a second inlet duct for the introduction of a comburent gas and a passageway which houses a second electrode so that said first electrode and second electrode are capable of generating a spark between them.

6. The combustion chamber according to claim 2, wherein
the first inlet arm contains a passageway which houses a first electrode, and
the second inlet arm contains an inlet duct for the introduction of a combustible gas and a comburent gas in a premixed condition, and a passage way, which houses a second electrode so that said first electrode and second electrode (E2) are capable of generating a spark between them.

7. The combustion chamber according to claim 1, wherein the combustion chamber has only one inlet arm.

8. The combustion chamber according to claim 7, wherein the inlet arm contains an inlet duct for the introduction of a combustible gas and a comburent gas in a premixed condition, and a passageway which houses an electrode arranged in such a way to generate a spark with said container wall.

9. The combustion chamber according to claim 7, wherein the inlet arm contains an inlet duct for the introduction of a combustible gas and a comburent gas in a premixed condition, a first passage way which houses a first electrode and a second passageway which houses a second electrode, the first electrode and the second electrode being arranged so as to generate a spark between them.

10. The combustion chamber according to claim 7, wherein the inlet arm contains a first inlet duct for the introduction of a combustible gas and a second inlet duct for the introduction of a comburent gas, and a passageway which houses an electrode arranged so as to generate a spark with said container wall.

11. The combustion chamber according to claim 7, wherein the inlet arm contains a first inlet duct for the introduction of a combustible gas and a second inlet duct for the introduction of a comburent gas, a first passage way which houses a first electrode and a second passage way which houses a second electrode, said first electrode and second electrode being arranged in such a way to generate a spark between them.

12). The combustion chamber according to claim 1, wherein the container is made of ceramic material and the at least one inlet arm is made of ceramic material as an electrically insulating material.

13. The combustion chamber according to claim 1, wherein each inlet arm consists of an inlet tube, which is integral with the container and has an internal surface, the inlet tube, of at least one inlet arm containing an embedding component in which at least one of the inlet ducts and the passageways is separated from the internal surface of the inlet tube, and from any other inlet duct and passageway.

14. The combustion chamber according to claim 13, wherein the embedding component is made of ceramic material.
